(19) United States
(12) Patent Application Publication
(10) Pub. No.: US 2005/0129603 A1
(43) Pub. Date: Jun. 16, 2005

(54) High-purity silica powder, and process and apparatus for producing it

(75) Inventors: Holger Szillat, Emmerting (DE); Fritz Schwertferger, Burghausen (DE); Bernd Haack, Perach (DE); Marcus Schafer, Traunstein (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munchen (DE)

(21) Appl. No.: 10/943,747

(22) Filed: Sep. 17, 2004

Related U.S. Application Data
(63) Continuation-in-part of application No. PCT/EP03/02316, filed on Mar. 6, 2003.

(30) Foreign Application Priority Data
Mar. 18, 2002 (DE) 102 11 958.9

(51) Int. Cl. C01B 33/12; B01J 8/04; B01J 10/00

(52) U.S. Cl. 423/335; 422/196; 422/198

(57) ABSTRACT

Use of a flame hydrolysis apparatus for preparing fumed silica particles or a plasma torch apparatus for sintering fumed silica particles to fused silica particles is capable of producing highly pure silica with non-silicon metal impurities less than 500 pb, when at least an inner nozzle is constructed of a silicon-containing material having a low level of non-silicon metal impurities. Preferably, all surfaces in the respective apparatus which contact silica are of similar construction. The silica contains a low level of impurities as produced, without requiring further purification.

### CROSS-REFERENCE TO RELATED APPLICATION

This application is a continuation-in-part of PCT application Ser. No. PCT/EP03/02316, filed Mar. 6, 2003, published in German, which claims the benefit of German Application No. 102 11 958.9, filed Mar. 18, 2002.

### BACKGROUND OF THE INVENTION

1. Field of the Invention

The invention relates to a high-purity silica powder and to a process and apparatus for producing it in a hot zone.

2. Description of the Related Art

High-purity silica powders are employed in numerous technical fields. Examples of application areas include optical fibers, quartz crucibles for pulling silicon single crystals, optoelectronics (e.g. lenses and mirrors), fillers in passive components used in electronics, and polishing suspensions for wafers (chemical mechanical polishing). A high powder purity is required for the abovementioned applications.

In optical fibers made from SiO₂ for optical communications, the radiation intensity of the information carrier light should not be reduced by absorption caused by impurities such as OH, iron and copper, or by scattering caused by bubbles, crystallization nuclei and inhomogeneities. Crystallization nuclei are formed by impurities such as calcium and magnesium.

In quartz glass crucibles, corrosion of the inner surface of the crucible occurs during the process of pulling silicon single crystals as a function of the number and type of impurities. Corrosion reduces the potential pulling time. Moreover, each additional impurity increases the number of nuclei at which oxygen precipitates may form during cooling of the single crystal.

In optical glasses, by way of example, sodium and transition metals are responsible for transmission losses in the glass. Therefore, it is necessary for the concentration of the transition metals not to exceed 100 ppb. Only then can it be ensured that the transmission at a wavelength of 248 nm is greater than 99.5% and at a wavelength of 193 nm is greater than 98%. Moreover, silica powders for optical fibers, quartz crucibles and glasses must be free of organic impurities, since otherwise numerous bubbles may form during the sintering step.

High-purity SiO₂ can also be used as a filler in epoxy resins for protecting IC chips if the concentration of the elements iron, sodium, and potassium does not exceed 0.2 ppm and the concentration of aluminum and titanium does not exceed 1 ppm. These elements change the coefficient of thermal expansion, the electrical conductivity, and the corrosion resistance of the passive components, which can deactivate the chip protection function.

Polishing suspensions of SiO₂ are used for direct polishing of semiconductor surfaces. The SiO₂ used for this purpose must not, for example, in the case of aluminum, exceed a concentration of 4 ppm.

A known process for producing high-purity silica powders is the hydrolysis of silicon-containing precursors. For example, SiCl₄ may be hydrolyzed in water in the presence of an organic solvent (Degussa DE 3937394), or by mixing ammonium fluorosilicate first with ammonia water and then with hydrofluoric acid (Nissan, JP 04175218), or by precipitating silica by the addition of a dilute mineral acid to an alkali metal silicate (Nippon, EP 9409167, University of Wuhan, CN 1188075). The silica so formed is also known as precipitated silica, and is used primarily as a catalyst support and as an epoxy resin filler for protecting LSI and VLSI circuit devices. The abovementioned processes produce porous, bubble-containing imperfect spherical particles with poor flow properties. A further, very significant drawback, is that these processes are subject to purity limitations, since certain impurities such as OH, C, F, N, as well as alkali metals such as Na and K, are to a certain extent introduced by the process. These drawbacks lead to considerable light scattering and absorption and to a reduced mechanical and thermal stability of the application product. Therefore, this process is fundamentally unsuitable for use in the optical fiber, crystal pulling crucible, and glass technology sectors.

Natural quartz is also ruled out for the above applications on account of the strict purity requirements. However, there have been many attempts to achieve acceptable purity levels by the additional process step of further purification of insufficiently pure quartz. According to DE 3123024 (Siemens), natural quartz is converted into thin fibers by melting, and then these fibers are subjected to a plurality of leaching process steps using acids and bases. On account of the high surface area and small thickness of the fibers, the level of transition metal ions can be reduced to less than 1 ppm. This process is inexpensive, since the fibers are used directly for applications in the optical fiber sector. If, for further applications and shaped body geometries, in accordance with DE 3741393 (Siemens), the purified fibers are milled, converted into a slip with the aid of water, dispersants, and other auxiliaries, and then a slip casting process and finally a sintering process are carried out, the ultimate result is a complex process with numerous contamination sources.

According to EP 0737653 (Heraeus), natural quartz is subjected to the process steps of milling, screening, preheating to 1000° C., treatment with Cl₂/HCl, cooling and desorption. This time-consuming process gives purities of around 70 ppb with regard to Fe. Impurities derived from alkaline-earth metals and Al, which are known to form cristobalite and therefore, for example, reduce crucible quality, cannot be removed to this extent, since these elements form chlorides of low volatility (prior to treatment: Na=1100 ppb, K=1050 ppb, Li=710 ppb, Ca>370 ppb, Al=16,000 ppb, Fe=410 ppb; subsequently: Na<10 ppb, K>80 ppb, Li=700 ppb, Ca>120 ppb, Al=16,000 ppb, Fe>30 ppb).

According to U.S. Pat. No. 4,818,510 (Quartz Technology), quartz can be purified further using HF. However, HF only reacts selectively with certain elements, such as iron, with which it forms readily soluble complexes.

Further purification has also been carried out on SiO₂ granules. According to U.S. Pat. No. 6,180,077 and EP 1088789 (Heraeus), SiO₂ granules are produced and are purified at high temperatures by means of HCl. One advantage is that the granules have a high surface area and can therefore be acted on more easily and more quickly by HCl. If the starting point granules have a purity of Na<50 ppb, Fe=250 ppb, Al<1 ppm, the further purification makes it possible to achieve very high purity levels (Na=5 ppb, Fe=10 ppb, Al=15 ppb). One disadvantage is that it is first necessary to produce highly porous silica granules (pore volume 0.5 cm³, pore diameter 50 nm, BET 100 m²/g, density 0.7 g/cm³, granule size 180-500 μm), which is a time-consuming process, and these granules do not yet represent the finished products, but rather, still have to be sintered. Furthermore, the high porosity conceals the latent risk of gases remaining included during sintering following shaping, for example, to form a crucible.

According to U.S. Pat. No. 4,956,059 (Heraeus), in addition to the purification gases Cl₂/HCl used at high temperatures, an electric field (typically 652 V/cm) can also be used in the further purification of silica granules. The further purification effect is stronger in the presence of the electric field, in particular with the alkali metal ions, which migrate well in the electric field, being affected by the field. This method makes it possible to reduce the sodium level, for example from 1 ppm to 50 ppb.

According to EP 1006087 (Heraeus), further purification can be carried out in a process where impure powder is heated in a gas stream, with the impurities softening and forming molten agglomerates, and the powder then being guided on to an impact surface, to which only the impure molten agglomerates adhere. This method only makes sense for very impure starting material powders. However, further purification with regard to high-melting oxides, such as MgO and Al₂O₃ is not possible in this way. The high quantities of gases required for this purpose represent a further drawback.

High purities (metal impurity levels<1 ppm, C<5 ppm, B<50 ppm, P<10 ppb) are achieved using the sol-gel process, in which first a sol and then a gel are formed from an organic silane and water. This is followed by the process steps of drying, calcining using inert gas, and sintering (Mitsubishi, EP 0831060, EP 0801026, EP 0474158). The process is very time-consuming and is also expensive, since high-purity organosilanes act as starting materials. In general, an organic-based rheological auxiliary, a dispersant and a solvent are used for the production process, with the result that the finished product may contain black carbon particles and CO and CO₂ bubbles. The use of water leads to a high OH content, and consequently to the formation of bubbles in the product and to a product having low thermal stability. If this material is used for producing silica crucibles for the production of Si single crystals using the Czochralski process, the bubbles and pores expand on account of the high temperature and the reduced pressure. During the pulling process, bubbles are responsible not only for turbulence in the silicon melt but also for the formation of crystal defects and a deterioration in the long-term stability of the crucible.

In principle, high-purity silica is also produced by precipitation of silica from high-purity organosilanes or SiCl₄ in the presence of an oxy-fuel flame using the CVD or OVD process (Corning, U.S. Pat. No. 5,043,002, U.S. Pat. No. 5,152,819, EP 0471139, WO 01/17919, WO 97/30933, WO 97/22553, EP 0978486, EP 0978487, WO 00/17115). However, this process does not produce powders, but rather glass bodies having a defined, simple geometry. The simple geometries include optical glasses and lenses. Optical fibers can be obtained from the high-purity glass body by drawing. To produce glass bodies of any other geometry from the simple glass bodies, the glass must first be milled to form a powder, dispersed, shaped, and sintered. However, this process can entail widespread contamination, in particular during the milling step.

A further drawback of this process is that expensive, high-purity organosilanes, such as, for example, octamethylcyclotetrasiloxane (OMCTS), are used in order to achieve particularly high purities.

High-purity SiO₂ layers can also be produced by deposition on high-purity substrates (e.g. by plasma CVD/OVD, GB 2208114, EP 1069083). One drawback of such a process is that it is only possible to achieve low deposition rates of 150 nm/min (e.g. J. C. Alonso et al., J. VAC. SCI. TECHNOL. A 13(6), 1995, pp. 2924 ff.) . Coating processes entail high production costs. High purity silica powders are not obtainable by these processes.

A simple alternative process is the formation of silica in a flame. Two different approaches are known in this respect. According to JP 5-193908 (Toyota/ShinEtsu), high-purity silicon metal powder can be oxidized to form high-purity silica powder by means of a CₙH₂ₙ₊₂/O₂ flame, the CₙH₂ₙ₊₂ being required only for ignition. However, the inventors themselves acknowledge the problem that the reaction produces a large number of unburnt particles. Full oxidation is difficult to realize unless the starting particles are very fine (0.2 μm). However, it is in turn almost impossible to produce such fine Si particles in a highly pure form.

Alternatively, fumed silica can be produced from SiCl₄ in an oxyhydrogen flame in a first step by flame hydrolysis and this fumed silica can be converted into fused silica by sintering in a second step.

The term fumed silica is to be understood as meaning ultrafine-particle, nanoscale powders which are produced by reacting silanes in a high-temperature flame and are often greatly aggregated and agglomerated. One typical example of fumed silica is Aerosil® OX 50 produced by Degussa, with a BET surface area of 50 m²/g. The term fused silica is to be understood as meaning coarser-grained, spherical glass powders. One typical example of fused silica is Excelica® SE-15 produced by Tokuyama with a mean particle size of 15 μm.

According to U.S. Pat. No. 5,063,179 (Cabot), the second substep, i.e. the production of fused silica, is implemented by fumed silica being dispersed in water, filtered, dried, purified further using SOCl₂ or Cl₂ and being sintered in a furnace. The concentrations of the impurities, such as Na and Fe, are then around 1 ppm (total content of impurities <50 ppm), i.e. still rather high.

According to JP 59152215 and JP 5330817 (Nippon Aerosil), in the second substep (the production of fused silica), the fumed silica powder is transferred in dispersed form, for example directly by means of a screw conveyer, into an oxyhydrogen flame and sintered to form fused silica powder.

According to JP 5301708 and JP 62-270415 (Tokuyama), to produce fused silica, high purity fumed silica is treated with H₂O vapor, cooled, fluidized, and fed by means of a screw conveyer to an oxyhydrogen flame for the purpose of sintering. The fused silica product obtained using the abovementioned processes contains >1000 ppb of impurities, as a cumulative sum of the elements Cu, Fe, Ti, Al, Ca, Mg, Na, K, Ni, Cr, Li. The dispersion and conveying of the fumed silica particles in accordance with the abovementioned processes is carried out, for example, with the aid of a screw conveyer. The screw is a moving part which becomes worn through contact with silica, in particular in the region of the edges. As a result, the screw contaminates the silica powder. Other components of the installation are also exposed to the abrasive silica particles and therefore to heavy wear. Mention should be made in particular of the burner nozzle, in which the velocities of the silica powders are particularly high.

### SUMMARY OF THE INVENTION

It was an object of the present invention to provide a silica powder of very high purity. A further object of the present invention was to provide a process and apparatus for the inexpensive production of the powder according to the invention. The first object is achieved by a silica powder in which the sum of impurities is less than 500 ppb. This and other objects are met by flame hydrolysis of high purity SiCl₄, the hydrolysis preferably taking place in a reactor having a metal-free surface.

### BRIEF DESCRIPTION OF THE DRAWINGS

FIG. 1 shows the burner outlet as a 3-tube burner nozzle without premixing of O₂ with SiCl₄ or fumed silica.

FIG. 2 shows the burner outlet comprising 7 nozzles without premixing of O₂ with SiCl₄ or fumed silica.

FIG. 3 shows the burner outlet comprising 7 nozzles with premixing of O₂ with SiCl₄ or fumed silica.

FIG. 4 shows the burner comprising 7 quartz glass nozzles with premixing of O₂ with SiCl₄ or fumed silica.

FIG. 5 shows the plasma torch.

FIG. 6 shows fused silica powder from Example 4.

### DETAILED DESCRIPTION OF THE PREFERRED EMBODIMENT

It is preferable for the total amount of impurities in the silica powder according to the invention to be less than 300 ppb, more preferably less than 150 ppb, and yet more preferably less than 100 ppb. Most preferably, the sum of impurities is less than 150 ppb and the individual impurity levels are Cu<1 ppb, Fe<25 ppb, Ni<2 ppb, Cr<2 ppb, Ti<3 ppb, Al<31 ppb, Ca<65 ppb, Mg<12 ppb, Na<12 ppb, K<6 ppb, and Li<1 ppb, and the powder is substantially carbon-free.

The impurity levels are determined using ICP analysis (inductively coupled plasma, apparatus: ICP-MS HP4500), for which the detection limit is less than 1 ppb. The silica powders may be either fumed silica or fused silica.

The fumed silica particles preferably have a BET surface area of between 50 and 300 m²/g, most preferably between 150 and 250 m²/g. The primary particle size is between 1 nm and 1000 nm, preferably between 5 nm and 100 nm, and most preferably between 10 nm and 30 nm.

The fused silica powder preferably has a mean particle size of between 100 nm and 200 μm, more preferably between 1 μm and 200 μm, and most preferably between 5 μm and 40 μm. Furthermore the powder preferably has a narrow particle size distribution, with D(95)−D(5)<50 μm, more preferably D(95)−D(5)<35 μm, e.g. with a mean particle size of D(50)=15 μm: D(5)=1 μm, D(95)=50 μm, more preferably D(5)=3 μm, D(95)=35 μm, measured using CILAS 715.

The narrow particle size distribution of the product produced according to the invention means that additional process steps such as screening, are not required, and the powder is directly suitable for further processing. FIG. 6 shows, by way of example, the very uniform particle size distribution of a fused silica powder which has been produced in accordance with Example 4.

The fused silica particles preferably have a spherical morphology and are completely vitrified. Unlike powders produced using the sol-gel process, they do not include any bubbles or carbon impurities originating from the use of organic solvents, dispersants and rheological agents.

The high-purity fumed silica and fused silica powders according to the invention can be used for all applications for which fumed and fused silica are useful. They are eminently suitable for the production of shaped bodies as described, for example, in DE 19943103 (Wacker Chemie GmbH).

A powder according to the invention is preferably produced by means of a process in which a high-purity fumed silica powder is obtained by hydrolysis of high-purity SiCl₄, wherein the hydrolysis of the SiCl₄ to form the fumed silica powder is carried out in an apparatus having a metal-free surface. The hydrolysis of the high-purity SiCl₄ is carried out in a flame comprising an oxygen-containing gas and a gas selected from the group consisting of hydrocarbon and hydrogen, or mixture thereof. The flammable gas mixture preferably comprises air or oxygen and methane, propane and/or hydrogen gas, most preferably, oxygen and hydrogen. Thus, hydrolysis preferably takes place in an H₂/O₂ flame. Alternatively, the hydrolysis may be carried out in a plasma, for example in an HF plasma.

It is also preferable for the deposition or “collection” of the fumed silica powder to be carried out in an apparatus with a metal-free surface.

Other suitable starting materials include silanes, organosilicon compounds, and halosilanes with an impurity level of <100 ppb. SiCl₄ with an impurity level of <100 ppb is very suitable, and SiCl₄ with the purity as set forth in Table 1 is preferably suitable.

A likewise high-purity fused silica powder can be produced from the fumed silica powder in accordance with the invention by sintering the fumed silica first produced. The sintering of the high-purity fumed silica powder is preferably carried out in an apparatus similar to that used to produce the fumed silica powder, in an H₂/O₂ flame or by means of an HF plasma. A controlled quantity of water can also be added to the fumed silica to control the particle size of the fused silica powder.

To avoid contamination from environmental elements, such as Na, K, Mg or Ca, it is preferable to work under clean room conditions and/or under a laminar flow. The process is, in this case, carried out under clean room conditions from classes 100,000 to 1, preferably 10,000 to 100, most preferably, 1000.

As an alternative to clean room conditions, the process can be carried out at a pressure of between 0.913 bar and 1.513 bar, preferably between 1.013 bar and 1.413 bar, and most preferably between 1.020 bar and 1.200 bar. The superatmospheric pressure prevents impurities from entering the installation.

If the inventive powder is produced in an H₂/O₂ flame, the apparatus according to the invention is preferably a nozzle comprising an inner tube located within an outer tube, with an annular space therebetween, and with a starting material selected from SiCl₄, a mixture of SiCl₄ with O₂, fumed silica, and a mixture of fumed silica with O₂ being passed through the inner tube, wherein the inner tube consists of a silicon-containing material with silicon as the main constituent, such as for example quartz glass, fused quartz, SiC, Si₃N₄, enamel, or silicon metal. Preferably, the surface of the material of the inner tube will have been purified, using a chlorine-containing gas, such as, for example SOCl₂, HCl, or Cl₂.

The apparatus is most preferably a nozzle in which the inner tube consists of quartz glass or a material with a quartz glass surface, which, again, has preferably been purified using a chlorine-containing gas such as, SOCl₂, HCl or Cl₂.

It is most preferable for the entire nozzle to consist of quartz glass or a material with a quartz glass surface. The purity can be increased still further if the quartz glass or the material with the quartz glass surface has been purified using, for example, SOCl₂, HCl or Cl₂.

If only the inner tube for the supply of fumed silica or SiCl₄ consists of quartz glass, while the remainder of the nozzle consists, for example, of steel, the purity of the powder produced is slightly worse than with a nozzle made from quartz glass, but is still higher than in the case of known silica powders.

Therefore, the invention also pertains to a nozzle comprising an inner tube located in an outer tube, with an annular space therebetween, wherein the inner tube consists of a silicon-containing material with silicon as the main constituent. This material is preferably selected from the group consisting of quartz glass, fused quartz, SiC, Si₃N₄, enamel or silicon metal. By the term “main constituents” is meant that the most substantial part of the metal content comprises silicon.

It is preferable for the nozzle to consist of a material selected from the group consisting of quartz glass, fused quartz, SiC, Si₃N₄, enamel or silicon metal, most preferably of quartz glass.

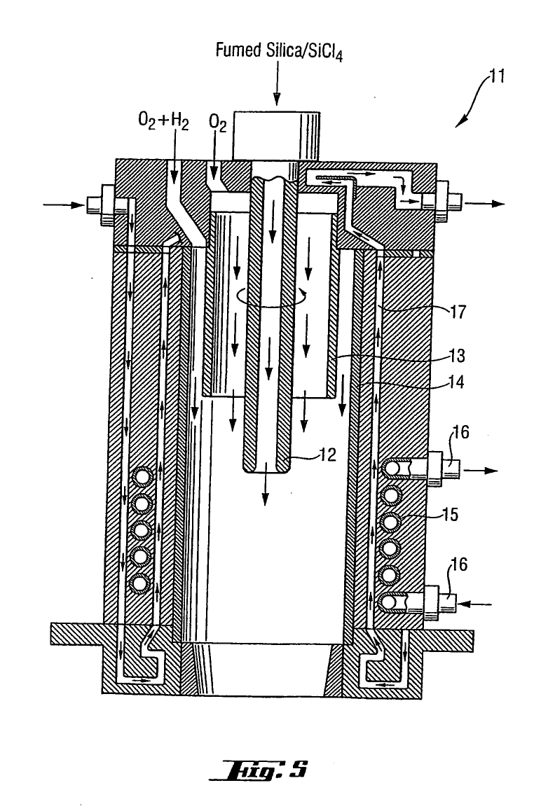

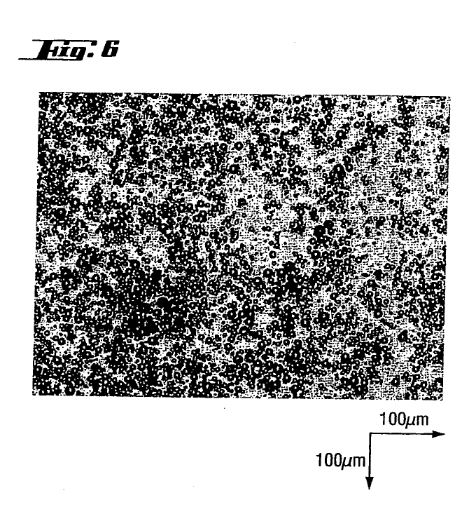

The nozzle is preferably a nozzle wherein premixing of the fuel gases is not employed. In a nozzle of this type, the fuel gases H₂ and O₂ are fed to the combustion chamber separately. In one embodiment of the nozzle according to the invention, SiCl₄ and/or fumed silica are premixed with one of the fuel gases, preferably with O₂, in a pilot chamber 7, and the mixture is then fed to the combustion chamber. The nozzle comprises an inner tube 5 for supplying the mixture of O₂ and fumed silica (SiCl₄) and an outer tube 6 for supplying H₂ (FIGS. 3 and 4).

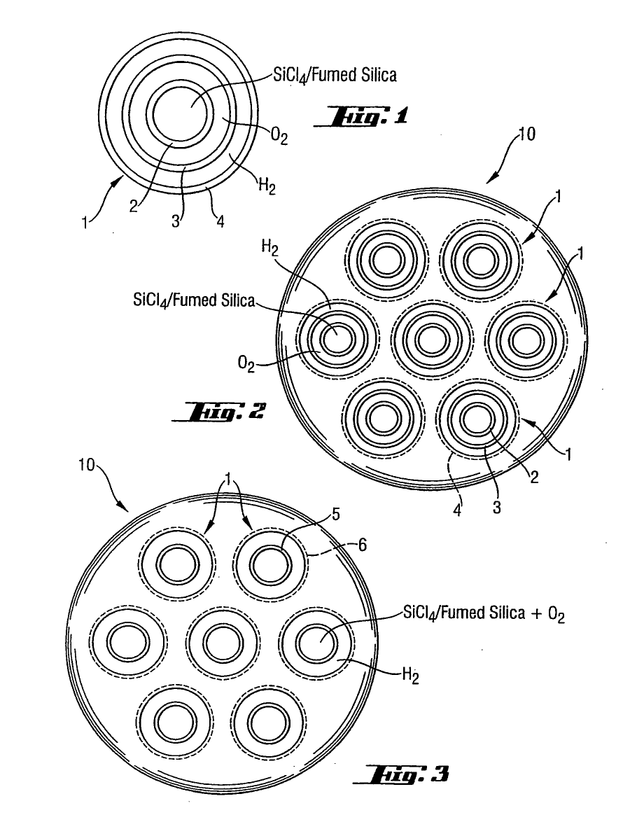

In another embodiment of the nozzle according to the invention, all the reactants (H₂, O₂, SiCl₄ and/or fumed silica) are fed to the combustion chamber separately. The nozzle comprises concentrically arranged tubes 2, 3, 4, for the supply of fumed silica (SiCl₄), O₂ and H₂. One possible arrangement comprises an inner tube for the supply of fumed silica (SiCl₄), a middle tube for the supply of O₂ and an outer tube for the supply of H₂ (FIG. 1).

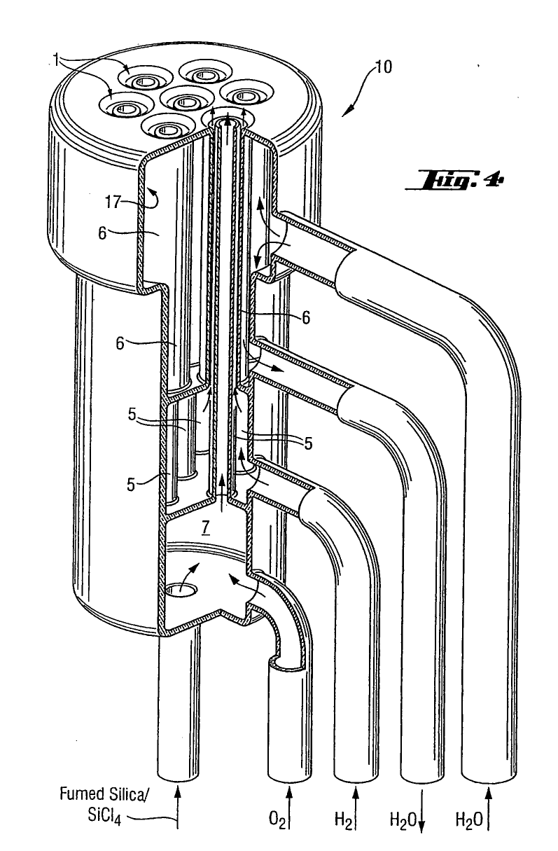

It is preferable for a burner 10 for producing powder according to the invention by means of H₂/O₂ flame to comprise a plurality of the nozzles. The burner delivers a powder with a narrow particle size distribution when a single nozzle is used, (FIG. 1), and a particularly narrow particle size distribution with a plurality of nozzles in which the starting materials are supplied through three concentric tubes (FIG. 2), and a yet further more narrow particle size distribution with a plurality of nozzles and an O₂/fumed silica premixing chamber with the starting materials being supplied through two concentric tubes 5, 6 (FIGS. 3 and 4). This arrangement allows a particularly homogeneous distribution of the SiCl₄, or of the fumed silica powder when producing fused silica powder, in the flame.

Therefore, the invention also relates to a burner 10 which includes 1 to 30, preferably 6 to 13, more preferably 7 nozzles. That surface of the burner which faces the combustion chamber preferably likewise consists of quartz glass. A burner 10 with 7 nozzles of this type is illustrated in FIG. 4, while FIG. 3 diagrammatically depicts a plan view of a burner of this type. FIG. 2 diagrammatically depicts a plan view of a burner with 7 nozzles in which all 3 starting materials, as described above, are introduced separately into the combustion chamber.

The dispersion of the fumed silica in the flame is improved still further in the variant of the nozzle according to the invention in which O₂ and fumed silica powder are premixed before being fed to the combustion chamber.

If the powder according to the invention is produced in a plasma, the apparatus according to the invention is a plasma torch 11 comprising a powder nozzle 12, an intermediate tube 13, and an outer tube 14 (FIG. 4), with the powder nozzle, the intermediate tube and the outer tube having a surface made from a silicon-containing material with silicon as the main constituent. It is preferable for the surface to consist of a material selected from the group consisting of quartz glass, fused quartz, SiC, Si₃N₄, enamel or silicon metal. It is preferable for the surface to be purified using a gas, such as SOCl₂, Cl₂ or HCl. SiCl₄ or the fumed silica powder is metered in via the powder nozzle, the plasma gas O₂ is metered in via the intermediate tube 13 and the shrouding gas mixture O₂ and H₂ is introduced via the outer tube.

It is highly preferable to use a plasma torch in which the powder nozzle, the intermediate tube and the outer tube have a surface made from quartz glass, especially a plasma torch having a surface made from quartz glass.

The plasma torch 11 furthermore has an induction coil 15 with water cooling 16 as well as a water cooling jacket 17.

High-purity powders can be produced directly using the apparatuses of the invention. The further purification process steps which are usually required are avoided. Fumed and fused silica powders of extremely high purities (Table 1), which have not been achieved using conventional processes, can be produced using a nozzle according to the invention. The purity can be increased still further by combustion in a nozzle made from quartz glass under clean room conditions. Furthermore, it is advantageous if all the surfaces of the installation for producing the fumed or fused silica powder which come into contact with a starting material in powder form, or the product according to the invention, are designed to be free from contamination. Therefore, an inventive apparatus for producing a silica powder is preferably distinguished by the fact that all the surfaces that come into contact with the silica powder are metal-free. “Metal-free” means free of metal other than silicon. An installation for producing a silica powder is known to comprise a) a metering apparatus, b) a burner, c) a combustion chamber, d) a cyclone and e) a silo. In the case of fumed silica production, a fluidized bed is generally also connected between the cyclone and the silo.

The materials which have been mentioned for the nozzle of the invention preferably also form the surface of the metering, the combustion chamber, the cyclone, the fluidized bed, and the silo. In another embodiment, the metering apparatus and the silo may also have a pure plastic surface. The plastics may, for example be PFA (perfluoroalkoxy copolymer), PTFE (polytetrafluoroethylene), Halar® E-CTFE, GFP (glass fiber-reinforced polyester resin) and PP (polypropylene). In the metering region, it is preferable for the silica powders to be conveyed without moving parts, for example by using pneumatic conveying by means of compressed air.

The following examples serve to further explain the invention.

### EXAMPLE 1

Production of a Fumed Silica Powder from SiCl₄ by Means of an Oxyhydrogen Flame without Clean Room Conditions

To produce a fumed silica powder from SiCl₄, the reactants SiCl₄, O₂ and H₂ are passed into the combustion chamber by means of a quartz glass nozzle without premixing. The reaction is carried out using 16.6 g/min of SiCl₄+6.3 l/min of O₂+8.9 l/min of H₂. The combustion chamber is operated at a pressure of 20 mbar above atmospheric pressure. Table 1 shows the analytical results.

### EXAMPLE 2

Production of a Fumed Silica Powder from SiCl₄ by Means of an Oxyhydrogen Flame using Clean Room Conditions

To produce a fumed silica powder from SiCl₄, the reactants SiCl₄, O₂ and H₂ are passed into the combustion chamber by means of a quartz glass nozzle without premixing. The reaction is carried out using 16.6 g/min of SiCl₄+6.3 l/min of O₂+8.9 l/min of H₂. The entire installation is in a clean room belonging to clean room class 10,000. Table 1 shows the analytical results.

### EXAMPLE 3

Production of a Fused Silica Powder from a Fumed Silica Powder by Means of an Oxyhydrogen Flame without Clean Room Conditions

To produce fused silica powder from fumed silica powder, the reactants fumed silica, O₂ and H₂ are passed into the combustion chamber by means of a quartz glass nozzle without premixing. The reaction is carried out using 180 l/min of H₂+90 l/min of O₂+60.3 g/min of fumed silica powder. The combustion chamber is operated at a pressure of 40 mbar above atmospheric pressure. Table 1 shows the analytical results.

### EXAMPLE 4

Production of Fused Silica Powder from Fumed Silica Powder by Means of an Oxyhydrogen Flame under Clean Room Conditions

To produce fused silica powder from fumed silica powder, the premixed reactants fumed silica powder, O₂ and H₂ are passed into the combustion chamber by means of a quartz glass nozzle. The reaction is carried out using 180 l/min of H₂+90 l/min of O₂+60.3 g/min of fumed silica powder. The entire installation is in a clean room belonging to clean room class 10,000. Table 1 shows the analytical results.

### EXAMPLE 5

Production of Fused Silica Powder from Fumed Silica Powder by Means of HF Plasma under Clean Room Conditions

To produce fused silica powder from fumed silica powder, the reactants fumed silica powder, air and H₂ are passed into the combustion chamber via a torch comprising quartz glass cylinders. The reaction is carried out using 45 l/min of O₂ as the central plasma gas, 90 l/min of O₂ and 25 l/min of H₂ as the shrouding gas and 15 kg/h of fumed silica powder, metered in via the powder nozzle. The pressure in the combustion chamber is 300 torr, and the total power of the HF plasma is 90 kW. In the present case, the plasma is an HF plasma in accordance with the principle of solid state technology, with which the person skilled in the art will be familiar. The entire installation is in a clean room belonging to clean room class 10,000. Table 1 shows the analytical results.

### EXAMPLE 6

Production of Fused Silica Powder from Fumed Silica Powder by Means of Oxyhydrogen Flame under Clean Room Conditions using Standard Nozzle, not Made from Quartz Glass

To produce fused silica powder from fumed silica powder, the reactants fumed silica powder, O₂ and H₂ are passed into the combustion chamber by means of a stainless steel nozzle with premixing. The reaction is carried out using 180 l/min of H₂+90 l/min of O₂+60.3 g/min of fumed silica powder. The entire installation is in a clean room belonging to clean room class 10,000. Table 1 shows the analytical results.

### COMPARATIVE EXAMPLE 7

Production of Fused Silica from Fumed Silica by Means of Oxyhydrogen Flame in Accordance with Patent JP 59152215.

The high-purity fumed silica powder is passed into an oxygen stream via a screw conveyer and then passed into the burner tube. The burner comprises 3 tubes, with 7.6 m³/h of H₂ being introduced into the combustion chamber via the inner and outer tubes, while the middle tube contains 3.8 m³/h of O₂ and 1.8 kg/h of fumed silica powder. Table 1 shows the analytical results.

TABLE 1
Impurity levels in the product produced in the respective
examples and of the SiCl₄ used, in ppb, determined using ICP/MS.

| Ex. | Cu | Fe | Ti | Al | Ca | Mg | Na | K | Ni | Cr | Li |
|---|---|---|---|---|---|---|---|---|---|---|---|
| 1 | <1 | 22 | 2 | 24 | 54 | 9 | 8 | 5 | 2 | 2 | <1 |
| 2 | <1 | 10 | <1 | 10 | 11 | 2 | 4 | 1 | <1 | <1 | <1 |
| 3 | <1 | 25 | 2 | 31 | 64 | 11 | 11 | 5 | 2 | 2 | <1 |
| 4 | <1 | 10 | <1 | 9 | 13 | 3 | 5 | 1 | <1 | <1 | <1 |
| 5 | <1 | 12 | <1 | 15 | 14 | 3 | 6 | 1 | <1 | <1 | <1 |
| 6 | <1 | 250 | 4 | 63 | 15 | 7 | 7 | 2 | 43 | 27 | <1 |
| C7 | 4 | 730 | <1 | 62 | 66 | 134 | 19 | 9 | 167 | 235 | <1 |
| SiCl₄ | <1 | 10 | <1 | 3 | 8 | <1 | 3 | 2 | <1 | <1 | <1 |

1. A fumed silica powder in which the sum of impurities is less than 500 ppb based on the weight of the silica powder as produced.

2. The fumed silica powder of claim 1 in which the sum of impurities is less than 150 ppb.

3. The fumed silica powder of claim 1, wherein the sum of impurities is less than 150 ppb and the individual impurity levels are Cu<1 ppb, Fe<25 ppb, Ni<2 ppb, Cr<2 ppb, Ti<3 ppb, Al<31 ppb, and Ca<65 ppb, Mg<12 ppb, Na<12 ppb, K<6 ppb, Li<1 ppb and the powder is carbon-free.

4. The fumed silica powder of claim 1, wherein the fumed silica powder has a BET surface area of between 50 and 300 m²/g.

5. The fumed silica powder of claim 1, wherein the fused silica powder has a mean particle size of between 100 nm and 200 μm.

6. The fumed silica powder of claim 5, which has a particle size distribution with D(95)−D(5)<50 μm.

7. Fused silica powder prepared by sintering a fumed silica powder of claim 1 to form a fused silica powder having a spherical morphology, which is completely vitrified, and which has a particle size distribution with D995)−D(5)<50 μm.

8. A process for producing the fumed silica powder of claim 1, comprising flame hydrolyzing high-purity SiCl₄ in an apparatus which has a metal-free surface.

9. A process for producing fused silica powder, comprising sintering a high-purity fumed silica powder of claim 5, wherein the sintering of the fumed silica powder is carried out in an apparatus with a metal-free surface.

10. The process of claim 8, which is carried out under clean room conditions.

11. The process of claim 9, which is carried out under clean room conditions.

12. The process of claim 10, which uses clean room conditions from classes 10,000 to 100.

13. The process of claim 8, which is carried out at a pressure of between 0.913 bar and 1.513 bar.

14. The process of claim 9, which is carried out at a pressure of between 0.913 bar and 1.513 bar.

15. A flame pyrolysis apparatus suitable for the flame hydrolysis of organosilicon compounds hydrolyzable at elevated temperatures in a flame of oxygen and combustible gas, or for the sintering of fumed silica particles to produce highly pure fused silica particles or a highly pure fumed silica of claim 1, the improvement comprising one or a plurality of nozzles each comprising at least an outer tube and an inner tube, the inner tube communicating with at least one of a source of hydrolyzable organosilicon compound or a source of fumed silica particles, the outer tube communicating with a source of oxygen or with a source of oxygen and combustible gas, wherein the inner tube is constructed of or coated with one or more silicon-containing materials selected from the group consisting of SiO₂, SiC, Si₃N₄, enamel, and silicon metal.

16. The apparatus of claim 15, wherein the surface of the inner nozzle has been purified by contact with a chlorine containing gas.

17. The apparatus of claim 15, further comprising a collection area for fumed silica particles or fused silica particles or both, the collection area having a metal-free surface.

18. The apparatus of claim 15, wherein all surfaces which contact silica are constructed of or coated with a silicon-containing material selected from the group consisting of SiO₂, SiC, Si₃N₄, enamel, and silicon metal.

19. A plasma torch apparatus suitable for preparing fused silica particles of claim 7, comprising an inner nozzles and an outer nozzle surrounding said inner nozzle, both nozzles constructed of or coated with a silicon-containing material devoid of non-silicon metal impurities on surfaces which contact silica particles, the inner nozzle in communication with a source of fumed silica powder, and the outer nozzle in communication with oxygen or a mixture of oxygen and a combustible gas.

20. The apparatus of claim 19, wherein said silicon-containing material is at least one selected from the group consisting of SiO₂, SiC, Si₃N₄, enamel, and silicon.

21. The apparatus of claim 19, further comprising a collection area for fused silica particles, said collection area constructed of or coated with a material devoid of non-silicon metal impurities.

22. In a process for the preparation of fumed silica particles or of fused silica particles wherein a silicon compound hydrolyzable at elevated temperatures by flame hydrolysis is hydrolyzed to fumed silica, or where fumed silica particles are sintered in a flame at high temperatures, the improvement comprising
providing a high temperature burner comprising:
an inner nozzle constructed of or coated with a silicon-containing material having a low concentration of non-silicon metal, said inner nozzle in communication with at least one of a source of silicon compound and fumed silica;
an outer nozzle surrounding said inner nozzle in spaced relationship thereto, a space between said inner nozzle and said outer nozzle in communication with a source of oxygen, with a source of oxygen and a source of combustible gas, or with a source of a mixture of oxygen and combustible gas;
providing at least one combustible gas to the apparatus and igniting a mixture of oxygen and combustible gas to form a flame proximate an end of said inner nozzle; and
flowing said silicon compound, said fumed silica, or both said silicon compound and said fumed silica through said inner nozzle to said flame; and
recovering fumed silica particles, fused silica particles, or a mixture of fumed silica particles and fused silica particles having non-silicon metal impurities and carbon impurities totaling less than 500 ppb based on the weight of silica.

23. The process of claim 22, wherein said outer nozzle is constructed of or coated with a silicon-containing material having a low concentration of non-silicon metal.

24. The process of claim 22, wherein all surfaces contacting silica are constructed of or coated with a silicon-containing material having a low content of non-silicon metal.

25. The process of claim 22, wherein said silicon-containing material is one or more selected from the group consisting of SiO₂, SiC, Si₃N₄, and silicon.

26. The process of claim 22, comprising providing a collection area for a silica particle product, said collection area constructed of or coated with a material having a low content of non-silicon metal impurities.

27. The process of claim 22, wherein a mixture of oxygen and fumed silica powder is introduced into said inner nozzle, and a fused silica particle product having a non-silicon metal impurity level of less than 150 ppb, a mean particle size between 100 nm and 200 μm, and a particle size distribution with D(95)−D(5)<50 μm is collected.
